(19) United States
(12) Patent Application Publication
(10) Pub. No.: US 2014/0324547 A1
(43) Pub. Date: Oct. 30, 2014

(54) Cloud network social engineering system and method for emerging societies using a low cost slate device

(71) Applicants: Masud Ekramullah Khan, Dhaka (BD); Khwaja Golam Mostafa, Dhaka (BD); Muhammad Imran Ali, Dhaka (BD); Elizabeth Anne Ali, Dhaka (BD)

(72) Inventors: Masud Ekramullah Khan, Dhaka (BD); Khwaja Golam Mostafa, Dhaka (BD); Muhammad Imran Ali, Dhaka (BD); Elizabeth Anne Ali, Dhaka (BD)

(21) Appl. No.: 13/986,400

(22) Filed: Apr. 29, 2013

(51) Int. Cl. G06F 3/0482; G06Q 50/26; G06Q 30/02

(52) U.S. Cl. CPC G06F 3/0482; G06Q 30/0206; G06Q 50/26
USPC 705/7.35; 715/738; 705/12

(57) ABSTRACT

The present invention teaches methods and systems for providing comprehensive cloud network resources to subscribing users comprising the acts of: providing a cloud network server including at least one data storage unit and at least one processor; providing at least one user device for accessing the cloud network server, the user device being communicatively coupled with the cloud network server; wherein the user device displays a menu including at least one menu item; and wherein the menu item is language irrelevant, wherein the language irrelevant menu item is identifiable without reference to written language. In accordance with a preferred embodiment the cloud server stores user data; and generates a menu responsive to the stored user data, including past menu selections by the user. Where stored user data includes geographic data; the cloud server generates dynamic information responsive to the user geographic data and responsive to past menu selections.

### BACKGROUND OF THE INVENTION

1. Field of the Invention

The present invention relates to computer network systems. In particular, the present invention teaches a computer implemented system and method for providing various social services over a cloud network to largely illiterate populations in emerging societies.

2. Description of the Prior Art

Currently several Fortune 500 companies such as Google, Amazon and Microsoft have developed cloud computing systems for technologically advanced industrial societies. Cloud computing generally consists of providing centralized computer resources to remote users via a network, typically the Internet. Currently this is primarily limited to data storage, shared applications, shared document creation, software development applications, and social media. Cloud computing entrusts a central system with remote user's data, computation and documentation. Advantages over traditional computers using individual software include increased data security, increased reliability, reduced hardware requirements for users and improved revenue collection for service providers.

FIG. 1 is a network block diagram illustrating a conventional cloud computing network at 100. A cloud server 102, including a data storage device 104 is connected with a cloud network 106. In most embodiments this cloud network 106 is a sub-network running on the Internet. Through the cloud network 106 user computers 110 can access the resources of the cloud server. User computers 110 can run applications on the cloud server 102 without needing as powerful a processor as they would to run the applications locally. Often these computers 110 do not require a hard disk drive because most required data is stored on a cloud server data storage system 104. In many applications this translates in users being able to use much lighter and less expensive computers 110 than they needed with traditional technologies. This includes an added benefit of data security, since all data is stored on the cloud server storage 104, and generally includes RAID features, security from unauthorized users and other data fail safes.

An even more important feature for vendors is that proprietary software and data remains on the cloud server. This effectively limits software and multi-media piracy and enables subscription pricing for software.

No prior art resources provide an easy to understand and efficient method for providing broad social services to developing societies. Furthermore, no prior art service provides educational resources remotely to functionally illiterate students. Additionally, no existing service provides affordable cloud network services to remote rural communities.

Further, no comprehensive technology provides government services such as voting and political resources to remote villages in emerging economies. Furthermore, no prior art cloud server methods exist for providing emergency medical treatment in remote areas.

What is needed is a computer system for providing comprehensive cloud network resources to subscribing users. Resources needed include education, emergency services, governmental services and market information.

Finally what is needed is a system that provides accessibility to cloud network resources regardless of educational level or literacy.

### SUMMARY

The present invention teaches methods and systems for providing comprehensive cloud network resources to subscribing users comprising the acts of: providing a cloud network server including at least one data storage unit and at least one processor; providing at least one user device for accessing the cloud network server, the user device being communicatively coupled with the cloud network server; wherein the user device displays a menu including at least one menu item; and wherein the menu item is language irrelevant, wherein the language irrelevant menu item is identifiable without reference to written language.

The present invention allows the monitoring of the view/usage and duration of views of contents by users and thereby measure the delivery of the information/contents with a higher degree of accuracy. This monitoring can identify users who could be targeted with further intervention through reminders or other forms of incentives.

In accordance with a preferred embodiment the cloud server stores user data; and generates a menu responsive to the stored user data, including past menu selections by the user. Where stored user data includes geographic data and is responsive to past menu selections.

The present invention teaches displaying an alphabetic menu including a plurality of letters of an alphabet; displaying an expanded view of a selected letter on a touch sensitive display in response to a first user input; generating an audio pronunciation of the selected letter; displaying a letter trace template of the selected letter, the letter trace template including a directional graphic indicating a path of proper letter formation; receiving a first tactile input from a user, wherein the first tactile input includes tracing a portion of the letter on the touch sensitive display, providing an audio response indicative of proper letter formation; prompting the user to add a ligature element, the ligature trace template including a direction graphic indicating a path of proper ligature formation; and receiving a second tactile input from the user forming the ligature element.

Taught in accordance with yet another embodiment the user device includes a wireless transmitter; wherein the wireless transmitter is configured to access a first wireless network associated with a first network protocol; and wherein the wireless transmitter is configured to access a second wireless network associated with a second network protocol; and wherein the first network protocol and the second network protocol are different network protocols.

Also taught is collecting individual market price data from users; collecting community market price data from third party sources; generating predicted market price data responsive to the individual market price data and the community market price data; and providing the predicted market price data to the users.

Also taught is providing a first symptom menu including a first plurality of symptom menu items; wherein each symptom menu item includes a graphical representation of a symptom of illness; receiving a first user input selecting a first symptom from the first plurality of symptom menu items; providing a second symptom menu including a second plurality of symptom menu items; wherein the second plurality of symptom menu items is responsive to the first user input receiving a second user input selecting a second symptom from the second plurality of symptom menu items; and generating a medical diagnosis in response to the first user input and the second user input.

Also taught in accordance with another embodiment is receiving an emergency report from a user; querying additional users in response to the emergency report; collecting corroborating emergency data from third party services; determining whether sufficient data exists for an emergency response; determining appropriate emergency response to the emergency report; determining appropriate geographic warning zone responsive to the emergency report; generating an emergency warning for transmission to users in the appropriate geographic warning zone; and transmitting emergency warning to user devices located within the appropriate geographic warning zone.

Also taught is a computer implemented method for providing comprehensive educational services to subscribing user via a cloud computer network comprising the acts of providing a cloud computer network for delivering educational services, the cloud computing network including a dedicated cloud server; providing a remote computer device for accessing the cloud computer network, the remote computer device including a wireless communication transmitter for communicating with the cloud computer network; testing user knowledge to determine a literacy level; storing user educational performance data, the user educational data including the literacy level; generating an educational menu responsive to the user educational data, the educational menu including a plurality of subjects; receiving a user input selecting a subject from the plurality of subjects; generating a lesson in response to the selected subject and the literacy level; and delivering the lesson to the remote computer device.

Finally what is taught is computer system for providing comprehensive social services in a developing society comprising: a mobile device for delivering comprehensive social services to an individual user; a cloud server for generating the comprehensive social services, the cloud server communicatively coupled with the mobile device via a cloud computer network; wherein the mobile device is operative for providing educational content to the individual user; wherein the mobile device is operative for receiving user input in response to the educational content and transmitting the user input to the cloud server; wherein the cloud server is operative for generating a skill value in response to the user input; wherein the cloud server is operative for generating an optimized lesson in response to the skill value; and wherein the mobile device is operative for providing the optimized lesson to the individual user.

### BRIEF DESCRIPTION OF THE DRAWINGS

FIG. 1 is a functional block diagram illustrating a cloud server network in accordance with the prior art;

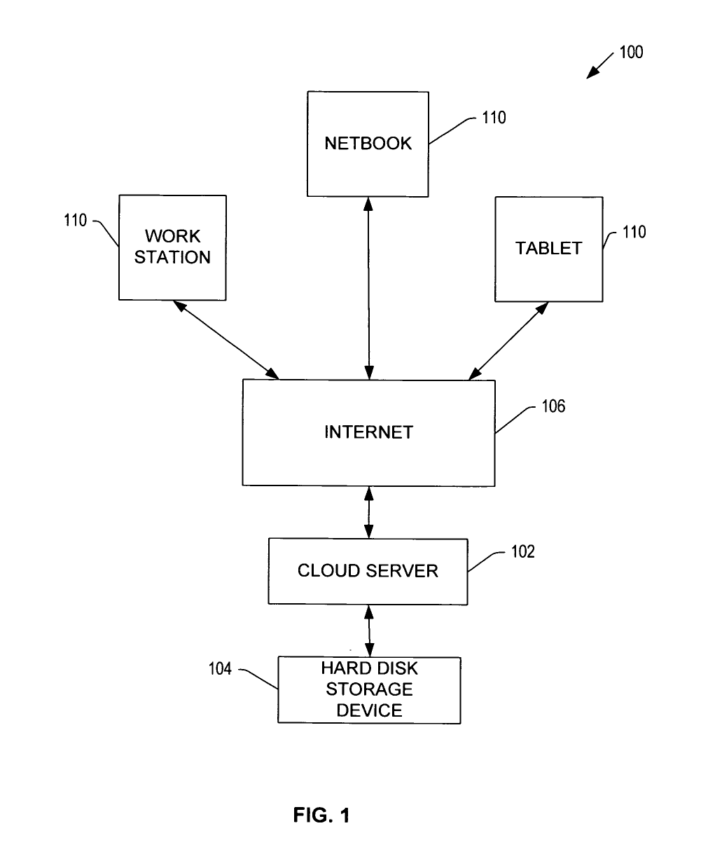

FIG. 2 is a functional block diagram illustrating the Amadeyr Cloud Network System in accordance with the present invention;

FIG. 3 is a pictoral diagram of a sample Slate device in accordance with the present invention;

FIG. 4 is a simplified flow chart diagram illustrating a process for generating user menus in accordance with one embodiment of the present invention;

FIG. 5 is a simplified flow chart diagram illustrating a process for providing remote emergency medical diagnosis and treatment in accordance with one embodiment of the present invention;

FIG. 6 is a simplified flow chart diagram illustrating a process for generating adaptive menus in accordance with one embodiment of the present invention;

FIG. 7 is a simplified flow chart diagram illustrating a process for teaching the proper formation of letters including ligatures in accordance with one embodiment of the present invention;

FIG. 8 is a simplified flow chart diagram illustrating a system for providing emergency alerts to remote regions of underdeveloped communities in accordance with one embodiment of the present invention; and

FIG. 9 is a simplified flow chart diagram illustrating a system for providing economic market data to remote regions of underdeveloped communities in accordance with one embodiment of the present invention.

### DETAILED DESCRIPTION OF THE PREFERRED EMBODIMENTS

In the following detailed description of the embodiments, reference is made to the drawings that accompany and that are a part of the embodiments. The drawings show, by way of illustration, specific embodiments in which the invention may be practiced. Those embodiments are described in sufficient detail to enable those skilled in the art to practice the invention and it is to be understood that other embodiments may be utilized and that structural, logical, and electrical changes as well as other modifications may be made without departing from the spirit and scope of the present invention.

The present invention teaches methods and systems for providing comprehensive cloud network resources to subscribing using the Amayder Delivery System (ADS). ADS addresses literacy as, retained “Information”, like any other “Information” in the traditional system, knowledge of literacy is a prerequisite to deciphering information coded in certain mediums, in this case the written medium. Here, the phonetics and visual representations are uniquely coded for every letter. In the new paradigm of ADS, knowledge of literacy/being literate is irrelevant to acquire information, enabling a simultaneous delivery of Information of all kinds inclusive of Information that actualizes learning of alphabets and hence literacy. ADS simultaneously delivers illiteracy proof information and enables users to gain literacy. This synergy is one of the many unique characteristics of the ADS. The Amayder Deliver System (ADS) operates to provide software as a service (SaaS), platform as a service (PaaS) and infrastructure as a service (IaaS).

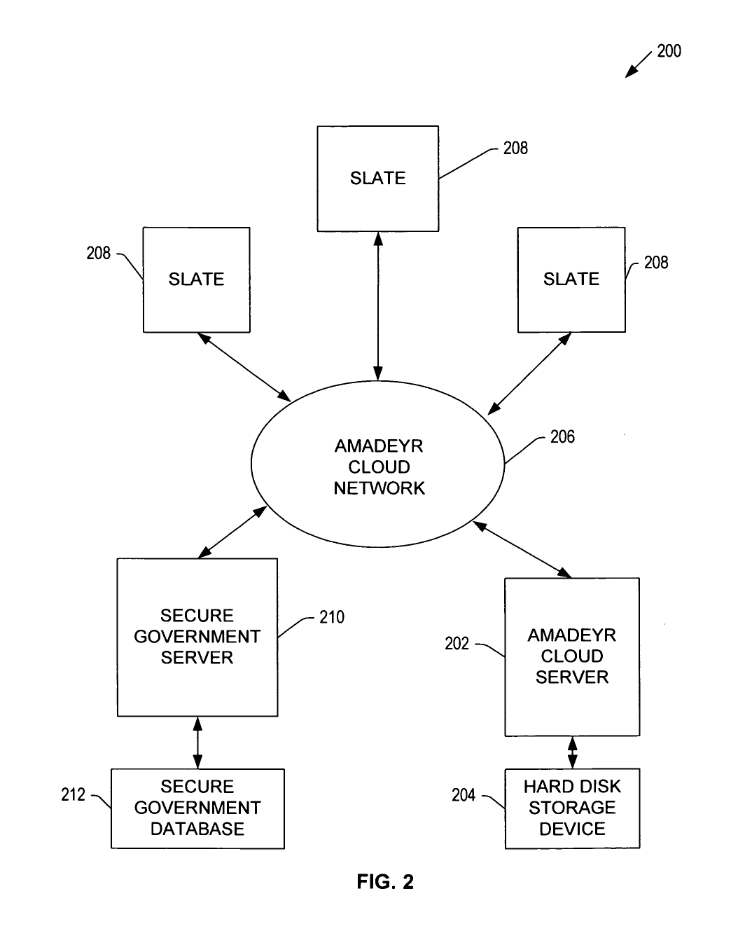

FIG. 2 is a functional block diagram illustrating the architecture for the Amadeyr Cloud Network system in accordance with a first embodiment of the present invention at 200. The Amadeyr Cloud Server 202 including secure hard disk memory 204 creates the Amadeyr Cloud Network 206. This cloud network 206 may include both a sub-network of the Internet as well as multiple other transmission networks. Examples include GSM, WiFi, long range WiFi, WMN (wireless mesh networks), dedicated hard line networks, satellite networks, or whatever communication technology is available in the intended geographical area. Some implementations may require significant modification of transmission protocols to work with existing infrastructure. The Amadeyr Cloud Network 206 is designed to be used in isolated and/or technologically underdeveloped areas with limited infrastructure and sometimes varied or archaic communications systems. Conventional cloud servers are limited to highly industrial zones having Internet access or used with dedicated transmission systems.

To access the Amadeyr Cloud Network users are provided with an inexpensive portable computer 208. A proprietary embodiment of this computer 208 will be called a Slate 208. The Slate 208 will have all the functionality of a basic tablet computer similar to an IPAD. The Slate is intended for distribution to villagers in emerging societies and as such will be constructed of low cost components, preferably with a majority of components being locally sourced. Alternatively, modified OEM tablet computers may be utilized.

In a preferred embodiment cloud server 202 is communicatively coupled to a government server 210 including secure government data base 212. The government server 210 and Amadeyr Server 202 would form a cooperative network infrastructure enabling a hybrid of governmental and quasi-governmental functions to reach remote villages and areas lacking public infrastructure.

A preferred embodiment of the present invention would include remote site voting in local and national elections. Security features may be incorporated to minimize fraud, such as simply limiting the number of votes a machine can transmit to the number of adults registered to use a specific Slate device 208. Other security features may include a finger print scan function for Slate devices 208. Alternative embodiments may include eye scans, face recognition, voice scans, etc. Such recognition security would be established by an authorized government official at the time a Slate device 208 is issued to a family or group.

In a preferred embodiment governmental server 210 would provide emergency alerts in times of crisis via the cloud network 206. Such emergency alerts would be tailored to geographical location of target populations. In accordance with an alternative embodiment Slate devices 208 could be remotely turned on by emergency alerts. Alerts may warn of tsunami, hurricane, earthquake, volcano, or other natural phenomena. Alerts may also warn of social unrest or criminal activity. In accordance with a preferred embodiment missing persons alerts may be implemented.

In accordance with a preferred embodiment the Amadeyr Cloud network will use the Eucalyptus Network Platform. Eucalyptus uses existing infrastructure to create scalable network services. Eucalyptus is compatible with Amazon APIs allowing access to the Amazon public cloud. This compatibility will allow the ADS to provide much a much broader array of services than a proprietary platform.

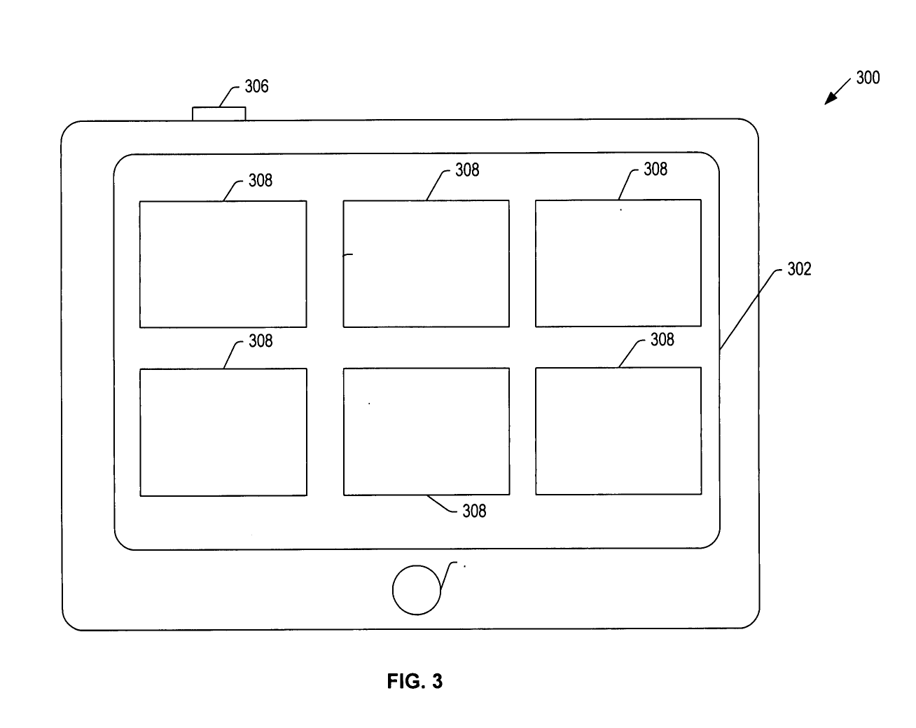

FIG. 3 illustrates a front view of a Slate wireless device at 300 in accordance with one embodiment of the present invention. The Slate 300 includes a large touch sensitive liquid crystal display 302, though less expensive display technologies may be substituted. A touch pad, track ball, or other device may be used as a low cost alternative to a touch sensitive LCD screen. In accordance with an alternative embodiment of the present invention the Slate 300 is an OEM tablet computer, netbook or laptop. The Slate 300 may include a camera 304 enabling users to use the Slate as a communication device. The Slate will include a communications port 306, and other ports enabling direct communication with other devices. Port 306 may include USB, Firewire, HDMI, Ethernet or other technologies.

Slate 300 will include an external power adapter suited to a variety of power sources that may be available in remote locations. In an alternative embodiment Slate 300 will include a hand crank mechanism, either built in or attachable to the device and also a portable solar cell charger.

Display screen 302 will display a menu including multiple menu items 308. A preferred embodiment includes a first menu showing pictures of users (generally family members or students authorized to use the device). Each user can touch their own picture in order to open their own personal menu in embodiments of the Slate in which menus are customizable.

Menu items 308 may include subjects that users might be interested in. The main menu may just have a few icons representing very broad subjects. Broad subjects may include topics like health care, agriculture, education, communication, Internet, etc. In accordance with the present invention menu item graphics are language irrelevant. This allows users to use the device without being literate in any particular language. Examples of language and or literacy irrelevant icons may include using a picture of a vegetable to represent an icon for agriculture, or a picture of an animal for an icon representing animal husbandry. An icon for medical care may include a picture of a person with a bandage over their face. This enables the device to be used by developing communities and illiterate populations. This also empowers women in societies where women do not have the same educational or professional opportunities as men. Furthermore, language irrelevant functionality provides educational opportunities for children who do not have access to traditional schooling.

Other examples of menu items 308 that would be available in developing nations include sanitation, animal husbandry, animal illness and treatment, shelter building, mosquito control, irrigation, treatment of acid burns, edible plants, etc. The informational needs of developing societies are wholly different than developed nations. For example, simple instruction for hand washing before meal preparation can have a dramatic effect on the health of families. In accordance with a preferred embodiment the Slate 300 would customize menus based on predicted needs. Such predictions would be based on past use of the Slate as well as geographic and demographic data.

Selecting a specific menu item will open a sub-menu until specifically desired information or functionality is achieved. When possible all menus and sub-menus are intended to be used by illiterate users. Methods of enabling this include using graphic information on menu items instead of written language. Also anticipated is enabling an auditory verbal broadcast in response to a cursor touching a menu item. Additionally menu items may expand into larger more detailed graphic images or pictures.

In an alternative embodiment the slate display 302 can function in a split screen mode. This can allow users to simultaneously input on one screen while following the activity of another person on the second screen. This can be used by teachers to instruct students remotely, or by peers in collaborative works.

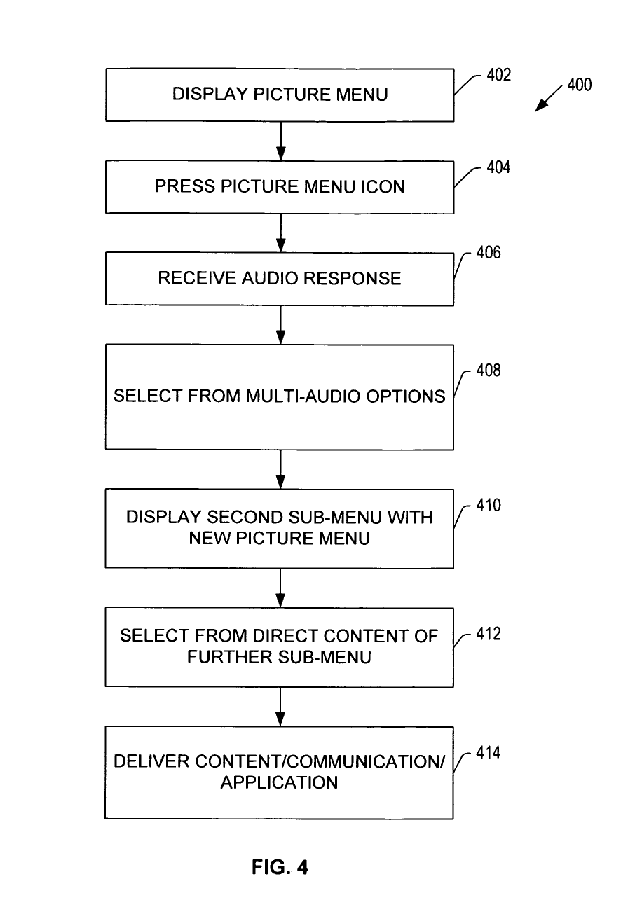

FIG. 4 shows a process for accessing a cloud network using the Slate at 400 in accordance with one embodiment of the present invention. At a step 402 the Slate displays a graphic menu to a user, graphics including some combination of pictures or computer graphics, animations or symbols. The main menu may just have a few icons representing very broad subjects. Broad subjects may include topics like health care, agriculture, education, communication, etc. In accordance with the present invention menu item graphics are language irrelevant. This allows users to use the device without being literate in any particular language. Examples of language irrelevant icons may include using a picture of a vegetable to represent an icon for agriculture, or a picture of an animal for an icon representing animal husbandry. An icon for medical care may include a picture of a person with a bandage over their face. At a step 404 the user touches a desired picture icon from the items included in the graphic menu. In response to the user's touch in a step 406 the Slate broadcasts an audio response.

This audio response will usually be additional information identifying the menu item and reinforcing the user's initial selection or providing a hint to help the user select the correct menu item. Often this will simply be a voice stating the title of the menu selection in one or more languages. An alternative example may be the broadcasting of animal sounds in response to a touch of an icon for animal husbandry. This becomes very helpful for illiterate or uneducated users who may not have grasped the full meaning of the menu item graphic. In a preferred embodiment in addition to the audio cue the icon graphic will explode into a larger picture. In a preferred embodiment the exploded graphic will be a different picture including more detailed information such as additional examples of what the menu item subject may include.

In a step 408 the user selects the desired menu icon in response to the audio cue. In a step 410 the Slate displays a sub-menu with a new set of menu icons or pictures. This sub-menu will narrow the focus of specific information that a user may seek. In a stop 412 the user selects from the displayed sub-menu items. This process of generating sub-menus can continue to narrow the scope of searches with subsequent sub-menus. In accordance with a preferred embodiment sub-menu generation is performed by an algorithm using data based on past user selections, demographic data and geographic data.

Finally in a stop 414 the slate delivers the desired content to the user. Desired content may include the running of software applications, the opening of communications links, access to the Internet, or the delivery of desired information.

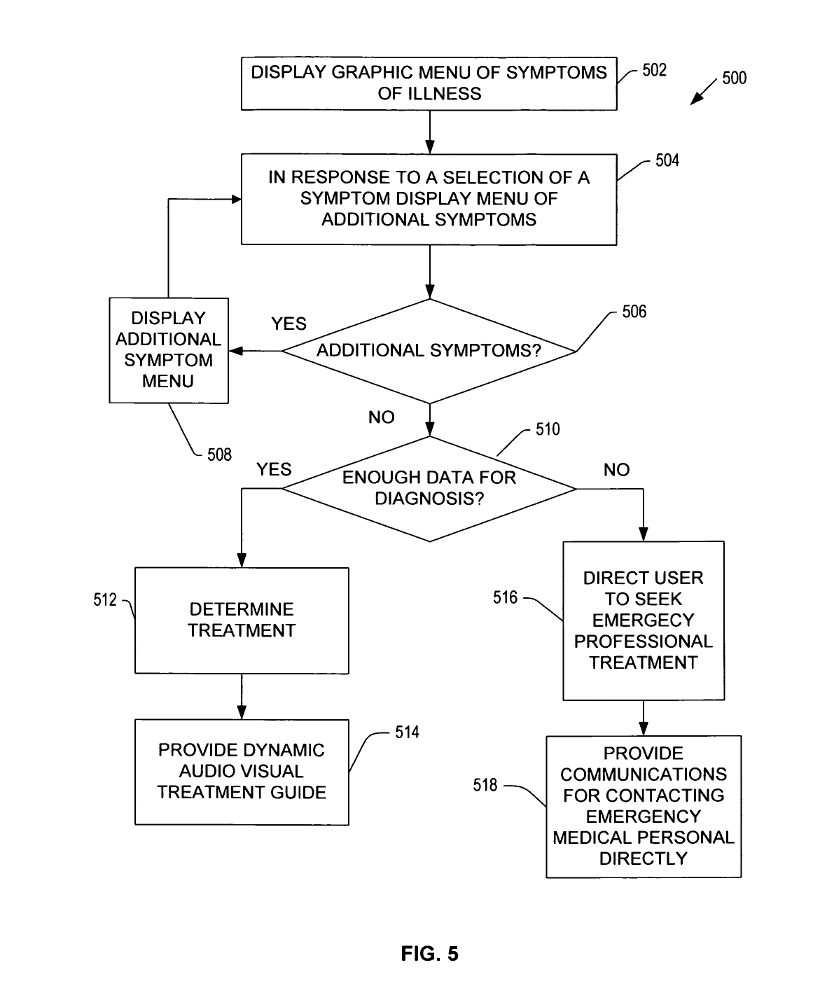

FIG. 5 illustrates a process at 500 for diagnosing and treating an illness in accordance with a preferred embodiment of the present invention. In a first step 502 a graphic menu of symptoms of illnesses is displayed. Each graphic icon may include an audio cue which is triggered upon a pointer or cursor passing over the icon. The audio cue serving to improve the comprehension of graphic menu items for illiterate or less sophisticated users.

In a step 504 once a user has selected a first symptom the Slate device displays a sub-menu of possible additional symptoms. If in a step 506, there are additional symptoms the process proceeds to step 508 where any such additional possible symptoms are displayed for selection.

Once all possible symptoms are exhausted the process continues to a step 510 where the cloud server determines if there is enough data to render medical advice. Data which would be a factor would include the number of systems, likelihood of error, difficulty of treatment and risk of mistreatment. If prescribing treatment is appropriate the cloud server would determine proper treatment in a step 512. Treatment information would be provided to the user in a step 514. Treatment information may take the form of a tutorial video and textual instructions.

If provided data is insufficient to prescribe treatment or treatment is considered too risky the user is instructed to seek professional attention in a step 516. In a step 518 the slate device establishes communications directly with emergency personnel via the cloud network.

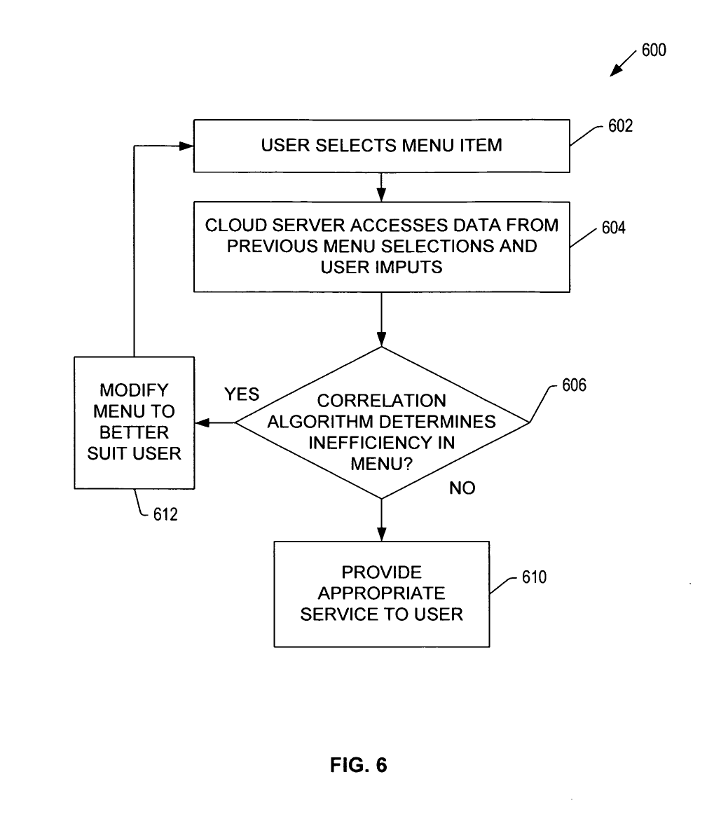

FIG. 6 shows a process at 600 for modifying sub-menu results in response to past user input in accordance with one embodiment of the present invention. The process begins at step 602, in which a user selects a menu item of subjects. In a step 604 the cloud server accesses data from previous user inputs. Data may also include data from other users based on similar selections, geographic, demographic and personalized background. Based on relevant data the cloud server determines whether the user selection produces redundancy, unanticipated selection, unusual selection, or other indication of poor menu generation.

If the menu items are considered below minimum standards of usefulness the cloud server will modify the existing menu or produce a sub-menu in order to better determine desired results in a step 612. Alternatively each menu may include a menu item indicating that none of the selections are useful. This would result in a menu being generated using different parameters than the previous menu.

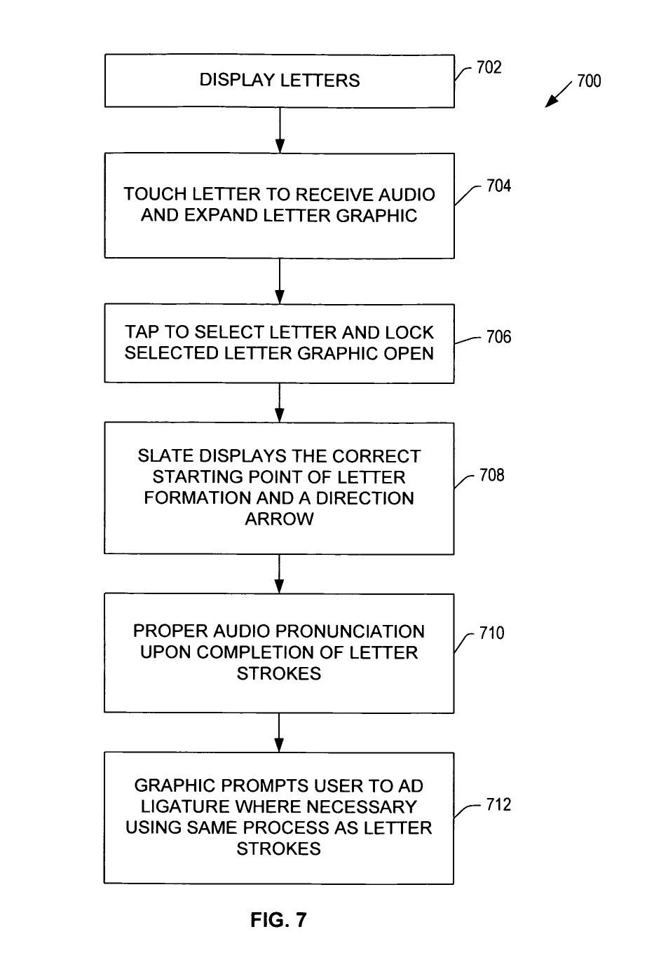

FIG. 7 shows a process for instructing students on the proper formation of letters of an alphabet at 700. This application is referred to as the Okkhar application. In a step 702 the Slate displays a group of letters. In a step 704 the display expands a letter in response to a light touch and broadcasts an audio pronunciation of the selected letter. In a step 706 a second tap locks open the expanded view. In a step 708 the Slate displays the selected letter and an indicator of the correct starting point for writing the letter as well as an arrow indicating the direction a pen stroke should travel from the starting point. In a preferred embodiment the letter will be an outline and will be graphically filled in as the user forms the letter.

In a step 710 the slate again pronounces the letter, this time to indicate the letter has been successfully completed. In a step 712 the slate prompts the user to ad a ligature where necessary using the same process used to form the letter. In accordance with a preferred embodiment the cloud server will determine an appropriate ligature based on previous and subsequent characters and upon proximity to the beginning or ending of lines of characters.

In writing and typography, a ligature occurs where two or more graphemes are joined as a single glyph. Ligatures often replace consecutive characters sharing common components. Ligatures are within a class of glyphs called “contextual forms”. The shape of a ligature depends on the context of surrounding letters.

In accordance with a preferred embodiment the Amadeyr Cloud server will be programmable by local educators though the Slate device to add new languages and new characters. Among the more common languages incorporating ligatures include: Sanskrit, Bengali, Urdu, Chinese, French and German. In accordance with a preferred embodiment the Okkhar application is accessed within standard lesson plans as a comprehensive educational curriculum.

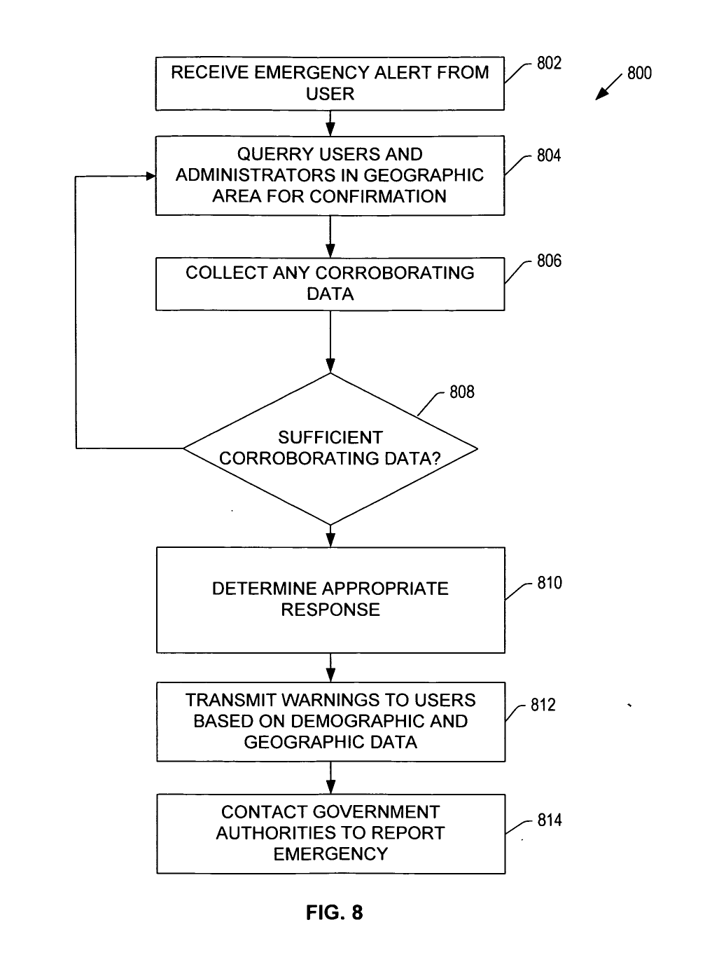

FIG. 8 shows a method for delivering emergency warnings and information using a cloud server at 800 in accordance with the present invention. In a step 802 a user reports an emergency on a Slate device. In accordance with a preferred embodiment of the present invention emergency menus are displayed in a language irrelevant manner similar to other Slate functions.

In a step 804 the cloud server queries users and any administrative agencies or personal in the geographic area of the user who made the initial report. In accordance with a preferred embodiment geographic area of query will depend upon the nature of the emergency. For example a forest fire will have a more limited relevant geographic zone than a tsunami or foreign military insurrection.

In a step 806 the cloud server will collect corroborating data. Such data would include information from weather services, government agencies, news agencies, etc. In a step 808 the cloud server will determine if sufficient corroboration exists to justify further action. If so the process continues to a step 810 where an appropriate response is determined. Then in a step 812 a warning message is sent to all Slate devices within a relevant distance to the confirmed emergency. Relevant distance will be determined in response to the nature and scope of the emergency. In a preferred embodiment warnings will be tailored to the demographic and geographic status of the receiving users. For example, Slate users with vehicles may be told to evacuate, while slate users without transportation may be told to walk to high ground.

In a step 814 the cloud server will report all relevant data to government authorities and international aid agencies. By delivering warnings to the people before the government bureaucratic delays can be avoided. This can be critical in developing societies with potentially dysfunctional governments.

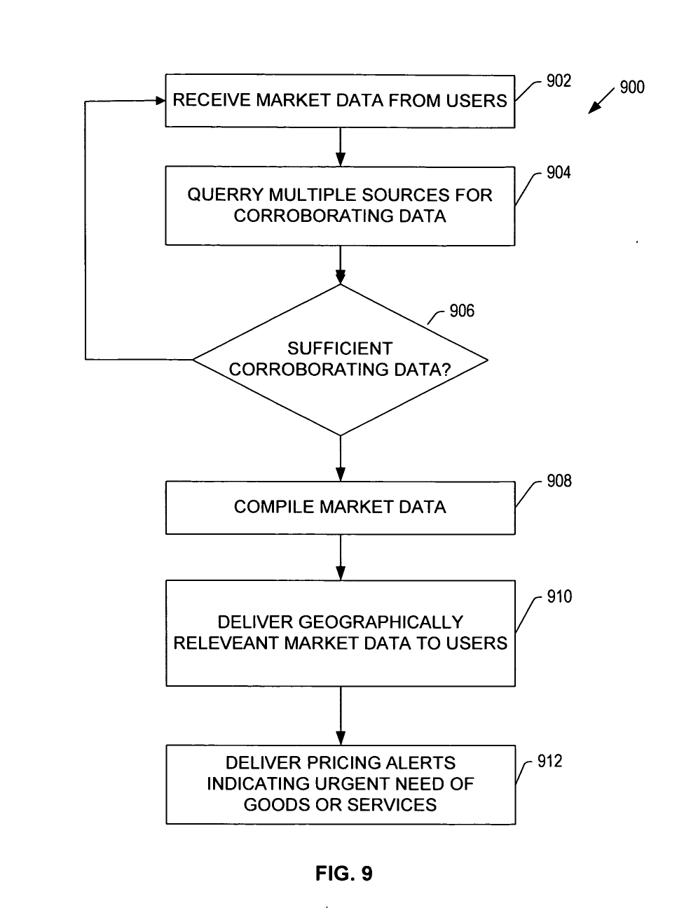

FIG. 9 shows a method for delivering market data in developing societies using a cloud server at 900 in accordance with the present invention. In a step 902 the cloud server receives market data reports from local users. Data may include the prices being offered for goods or services in a particular village, or offers of sale for goods or services within general geographic areas. In a step 904 the cloud server will query multiple sources for additional data. Data may come from individual users, government sources and non-governmental entities.

In a step 906 it will be determined if sufficient data exists to provide market data to users. This determination will be waited based on the number of reports and the historical voracity of reporting entities. If collected data is of insufficient quality to warrant a price report then the cloud server will continue to collect additional data. If reliability thresholds for pricing are reached all relevant market data is compiled in a step 908. Compilation of data may include weighted averaging of prices to generate a predicted market price.

In step 912 geographically relevant market data is delivered to local users. Geographic relevancy will be determined based on the type of goods or services being traded. For example, perishable fruits and live stock will have a narrow geographic relevance while machine parts may be effectively traded internationally. This allows small producers to effectively compete even with multinational entities. This functionality is expected to be a great equalizer in the commerce of developing nations which are normally ripe for extortion by powerful interests.

The foregoing examples illustrate certain exemplary embodiments of the invention from which other embodiments, variations, and modifications will be apparent to those skilled in the art. The invention should therefore not be limited to the particular embodiments discussed above, but rather is defined by the following claims.

What is claimed is:

1. A computer implemented method for providing comprehensive cloud network resources to subscribing users comprising the acts of:
providing a cloud network server including at least one data storage unit and at least one processor;
providing at least one user device for accessing said cloud network server, said user device being communicatively coupled with said cloud network server;
wherein said user device displays a menu including at least one menu item; and
wherein said menu item is language irrelevant, wherein said language irrelevant menu item is identifiable without reference to written language.

2. A computer implemented method as recited in claim 1, wherein said user device includes a touch sensitive display for receiving user input further comprising:
displaying an alphabetic menu including a plurality of letters of an alphabet;
displaying an expanded view of a selected letter on a touch sensitive display in response to a first user input;
generating an audio pronunciation of said selected letter;
displaying a letter trace template of said selected letter, said letter trace template including a directional graphic indicating a path of proper letter formation;
receiving a first tactile input from a user, wherein said first tactile input includes tracing a portion of said letter on said touch sensitive display;
providing an audio response indicative of proper letter formation;
prompting said user to add a ligature element for said selected letter;
displaying a ligature trace template of said ligature element, said ligature trace template including a directional graphic indicating a path of proper ligature formation; and
receiving a second tactile input from said user forming said ligature element.

3. A computer implemented method as recited in claim 1, wherein each said menu item has a computer software application associated with said menu item and wherein said user device provides feedback to the user for a preview of said menu item; wherein said feedback provides the user with additional information about the menu item without fully activating said associated software application.

4. A computer implemented method as recited in claim 3, further comprising:
wherein said menu item includes a graphic element;
wherein said graphic element is language independent;
wherein said additional information includes audio feedback;
wherein a user selection activates a display of a sub-menu including multiple sub-icons;
wherein each sub-icon is associated with a distinct audio element;
wherein each sub-icon is associated with an associated information content; and
wherein each sub-icon is selectable to deliver said associated information content.

5. A computer implemented method as recited in claim 1, wherein said cloud server stores user data; and wherein said cloud server generates said menu responsive to said stored user data.

6. A computer implemented method as recited in claim 5, wherein said stored user data includes past menu selections by said user.

7. A computer implemented method as recited in claim 6, wherein said user data includes user geographic data; and wherein said cloud server generates dynamic information responsive to said user geographic data and responsive to said past menu selections.

8. A computer implemented method as recited in claim 1, wherein said user device includes a wireless transmitter; wherein said wireless transmitter is configured to access a first wireless network associated with a first network protocol; and wherein said wireless transmitter is configured to access a second wireless network associated with a second network protocol; and wherein said first network protocol and said second network protocol are different network protocols.

9. A computer implemented method as recited in claim 8, wherein said first wireless network comprises a cellular network and wherein said second wireless network comprises a Wi-Fi network.

10. A computer implemented method as recited in claim 1, further comprising:
collecting individual market price data from users;
collecting community market price data from third party sources;
generating predicted market price data responsive to said individual market price data and said community market price data; and
providing said predicted market price data to said users.

11. A computer implemented method as recited in claim 1, further comprising:
providing a first symptom menu including a first plurality of symptom menu items; wherein each symptom menu item includes a graphical representation of a symptom of illness;
receiving a first user input selecting a first symptom from said first plurality of symptom menu items;
providing a second symptom menu including a second plurality of symptom menu items;
wherein said second plurality of symptom menu items is responsive to said first user input receiving a second user input selecting a second symptom from said second plurality of symptom menu items; and
Generating a medical diagnosis in response to said first user input and said second user input.

12. A computer implemented method as recited in claim 11, further comprising:
receiving geographic data associated with a user;
selecting emergency medical personnel in response to said medical diagnosis and said geographic data;
providing said first user input to said selected emergency medical personnel; and
providing said second user input to said selected emergency medical personnel.

13. A computer implemented method as recited in claim 11, further comprising:
displaying dynamic audio visual treatment instruction responsive to said medical diagnosis to a user; wherein said dynamic audio visual instruction is displayed with said user device.

14. A computer implemented method as recited in claim 1, further comprising:
receiving an emergency report from a user;
querying additional users in response to said emergency report;
collecting corroborating emergency data from third party services;
determining whether sufficient data exists for an emergency response;
determining appropriate emergency response to said emergency report;
determining appropriate geographic warning zone responsive to said emergency report;
generating an emergency warning for transmission to users in said appropriate geographic warning zone; and
transmitting emergency warning to user devices located within said appropriate geographic warning zone.

15. A computer implemented method as recited in claim 14, further comprising:
determining a selected government action in response to said emergency report;
determining a selected government agency from a plurality of government agencies in response to said emergency report; and
transmitting said selected government action to said selected government agency.

16. A computer implemented method as recited in claim 15, wherein said selected government agency is determined in response to said determined appropriate geographic warning zone; and wherein said selected government agency is determined in response to said selected government action.

17. A computer implemented method as recited in claim 1, further comprising:
establishing a first encrypted connection between said cloud network server and said user device;
receiving voter identification information from a voter;
Establishing a second encrypted connection between said cloud network server and a government server;
delivering said voter identification information to said government server;
displaying a governmental election menu including a plurality of political candidates;
receiving a voter input indicating a selected political candidate; and
delivering said voter input to said government server.

18. A computer implemented method as recited in claim 1, further comprising:
receiving voter identification information from a voter;
delivering said voter identification information to a government server;
authenticating said voter identification information;
displaying a voter referendum menu including a proposed referendum;
displaying a plurality of responses to said proposed referendum;
displaying educational information associated with said proposed referendum;
receiving a voter input indicating a selected response to said proposed referendum; and
delivering said selected response to said government server.

19. A computer implemented method for providing comprehensive educational services to subscribing users via a cloud computer network comprising the acts of:
providing a cloud computer network for delivering educational services, said cloud computing network including a dedicated cloud server;
providing a remote computer device for accessing said cloud computer network, said remote computer device including a wireless communication transmitter for communicating with said cloud computing network;
testing user knowledge to determine a literacy level;
storing user educational performance data, said user educational data including said literacy level;
generating an educational menu responsive to said user educational data, said educational menu including a plurality of subjects;
receiving a user input selecting a subject from said plurality of subjects;
generating a lesson in response to said selected subject and said literacy level; and
delivering said lesson to said remote computer device.

20. A computer system for providing comprehensive social services in a developing society comprising:
A mobile device for delivering comprehensive social services to an individual user;
A cloud server for generating said comprehensive social services, said cloud server communicatively coupled with said mobile device via a cloud computer network;
wherein said mobile device is operative for providing educational content to said individual user;
wherein said mobile device is operative for receiving user input in response to said educational content and transmitting said user input to said cloud server;
wherein said cloud server is operative for generating a skill value in response to said user input;
wherein said cloud server is operative for generating an optimized lesson in response to said skill value; and
wherein said mobile device is operative for providing said optimized lesson to said individual user.
